(19) United States
(12) Patent Application Publication
(10) Pub. No.: US 2015/0002499 A1
(43) Pub. Date: Jan. 1, 2015

(54) PIXEL, ORGANIC LIGHT DISPLAY DEVICE HAVING THE PIXEL, AND DRIVING METHOD OF THE ORGANIC LIGHT EMITTING DISPLAY DEVICE

(71) Applicant: Samsung Display Co., Ltd., Yongin-City (KR)

(72) Inventors: Hyung-Soo KIM, Yongin-City (KR); Chul-Kyu KANG, Yongin-City (KR); Dong-Gyu KIM, Yongin-City (KR); Yong-Jae KIM, Yongin-City (KR)

(21) Appl. No.: 14/315,654

(22) Filed: Jun. 26, 2014

(30) Foreign Application Priority Data
Jul. 1, 2013 (KR) 10-2013-0076310

(51) Int. Cl. G09G 3/32

(52) U.S. Cl. CPC G09G 3/3208
USPC 345/211; 315/172; 345/76

(57) ABSTRACT

An organic light emitting display includes a plurality of pixels. Each pixel includes an organic light emitting diode, a first driver, and a second driver. The first driver supplies a predetermined current to the OLED based on a current data signal or first data signal. The second driver is coupled between the first driver and OLED, and controls the coupling between the first driver and OLED based on a second data signal.

### CROSS-REFERENCE TO RELATED APPLICATION

Korean Patent Application No. 10-2013-0076310, filed on Jul. 1, 2013, and entitled, “Pixel, Organic Light Display Device Having The Pixel, and Driving Method Of The Organic Light Emitting Display Device,” is incorporated by reference herein in its entirety.

### BACKGROUND

1. Field

One or more embodiments described herein relate to a display device.

2. Description of the Related Art

Various types of flat panel displays have been developed. Examples include liquid crystal displays, field emission displays, plasma display panels, and an organic light emitting displays. Organic light emitting displays display images using organic light emitting diodes (OLEDs) that emit light based on a recombination of electrons and holes in an active layer. Organic light emitting displays have fast response speed and low power consumption and therefore are of interest to system designers.

### SUMMARY

In accordance with one embodiment, a pixel includes an organic light emitting diode (OLED); a first driver configured to supply a predetermined current to the OLED based on a current data signal or first data signal; and a second driver coupled between the first driver and OLED, the second driver to control the coupling between the first driver and OLED based on a second data signal.

The first driver may include a first transistor between a first power source and a second node which is electrically coupled to the second driver, the first transistor having a gate electrode coupled to a first node; a second transistor coupled between the second node and a data line, the second transistor to be turned on when a first scan signal is supplied to a first scan line; a third transistor coupled between the first and second nodes, the third transistor to be turned on when the first scan signal is supplied; and a first capacitor coupled between the first node and the first power source.

The predetermined current may flow into a data line through the first power source, the first transistor, and the second transistor when the current data signal is supplied. The first data signal may be set to a voltage substantially equal to a voltage applied to the first node, corresponding to the current data signal.

The second driver may include a fourth transistor coupled between the second node and OLED; a fifth transistor coupled between a gate electrode of the fourth transistor and a data line, the fifth transistor to be turned on when a second scan signal is supplied to a second scan line; and a second capacitor coupled between the gate electrode of the fourth transistor and the first power source. The second data signal may be set to a turn-on voltage to turn on the fourth transistor to cause the OLED to emit light, or to a turn-off voltage to turn off the fourth transistor to prevent the OLED from emitting light.

In accordance with another embodiment, an organic light emitting display device includes a scan driver configured to supply a first scan signal to first scan lines and to supply a second scan signal to second scan lines; a data driver configured to supply first and second data signals to data lines; a current sink unit configured to supply a current data signal to the data lines; and pixels in an area defined by the first scan lines, the second scan lines, and the data lines, wherein an organic light emitting diode (OLED) of each pixel is to receive an amount of current controlled based on one of the current data signal or the first data signal, and wherein the OLED has an emission time controlled based on the second data signal.

The display device may include a selection unit configured to allow the data lines to be selectively coupled to the current sink unit and the data driver. The current sink unit may sink a predetermined current from the pixels based on the current data signal and synchronized with the first scan signal at least once.

The display device may include a controller configured to convert a voltage applied to each pixel into a digital value corresponding to the predetermined current, and to store the converted digital value in a storage unit. The data driver may convert the digital value into the first data signal as a voltage, and may supply the converted first data signal to the pixels, in synchronization with the first scan signal. The first data signal may be supplied for each of a plurality of frames.

The current level of the current data signal may be set to allow a voltage corresponding to the current data signal to be charged in the pixels during a period in which the first scan signal is supplied.

The data driver may be supplied the second data signal in synchronization with the second scan signal. The second data signal may be set to one of a turn-on voltage at which the pixels emit light or a turn-off voltage at which the pixels do not emit light. The second data signal may be supplied to the pixels at least once for each frame.

Each pixel may include an organic light emitting diode (OLED); a first driver configured to supply a predetermined current to the organic light emitting diode based on the current data signal or first data signal; and a second driver coupled between the first driver and OLED, wherein the second driver is to control the coupling between the first driver and OLED based on the second data signal.

The first driver may include a first transistor coupled between a first power source and a second node electrically coupled to the second driver; a second transistor coupled between the second node and a data line, the second transistor to be turned on when a first scan signal is supplied to a first scan line; a third transistor coupled between the first and second nodes, the third transistor to be turned on when the first scan signal is supplied to the first scan line; and a first capacitor coupled between the first node and the first power source.

The second driver may include a fourth transistor coupled between the second node and the OLED; a fifth transistor coupled between a gate electrode of the fourth transistor and the data line, the fifth transistor to be turned on when a second scan signal is supplied to a specific second scan line; and a second capacitor coupled between the gate electrode of the fourth transistor and the first power source.

In accordance with one embodiment, a method of driving an organic light emitting display device includes sinking current based on a current data signal from a pixel; converting a voltage applied to the pixel into a digital value based on the sinked current and storing the converted digital value; charging a predetermined voltage by supplying, to the pixel, a first data signal as a voltage corresponding to the digital value; and controlling an emission time of the pixel based on a second data signal.

### BRIEF DESCRIPTION OF THE DRAWINGS

Features will become apparent to those of skill in the art by describing in detail exemplary embodiments with reference to the attached drawings in which:

FIG. 1 illustrates an embodiment of a display device;

FIG. 2 illustrates another embodiment of a display device;

FIG. 3 illustrates an embodiment of a pixel;

FIG. 4 illustrates an embodiment of a driving waveform;

FIG. 5 illustrates another embodiment of a driving waveform;

FIG. 6 illustrates another embodiment of a driving waveform;

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

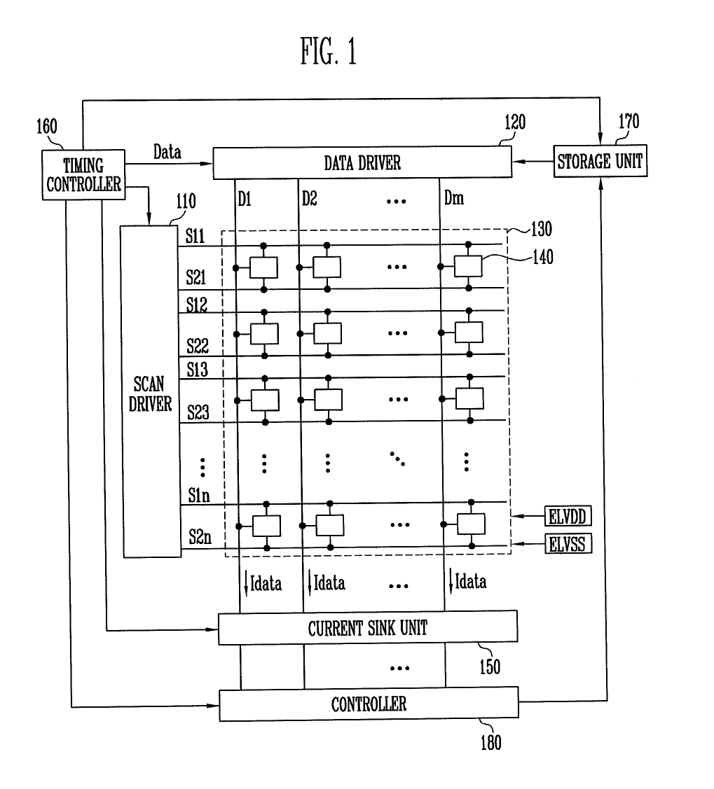

FIG. 1 illustrates an embodiment of an organic light emitting display device which includes a pixel unit 130, a scan driver 110, a data driver 120, a current sink unit 150, a storage unit 170, a controller 180, and a timing controller 160. The pixel unit 130 includes a plurality of pixels 140.

The scan driver 110 supplies a first scan signal to first scan lines S11 to S1n during a sensing period and a driving period. For example, the scan driver 110 may progressively supply the first scan signal to the first scan lines S11 to S1n during the sensing period. When the first scan signal is progressively supplied to the first scan lines S11 to S1n, pixels 140 are selected for each horizontal line.

During the driving period, the scan driver 110 supplies the first scan signal to the first scan lines S11 to S1n, and supplies a second scan signal to second scan lines S21 and S2n. For example, scan driver 110 may progressively supply the first scan signal to the first scan lines S11 to S1n during the driving period. The scan driver 110 supplies one or more second scan signals to each of the second scan lines S21 to S2n during one frame.

Specifically, scan driver 110 supplies the first scan signal to an i-th (i is a natural number) first scan line S1i during a specific frame. After the first scan signal is supplied to the i-th first scan line S1i, the scan driver 110 supplies one or more second scan signals to an i-th second scan line S2i. For example, the scan driver 110 may supply a plurality of scan signals to the i-th second scan line S2i at a predetermined interval.

The current sink unit 150 supplies a current data signal Idata to data lines D1 to Dm, in synchronization with the first scan signal. The supplied current data signal Idata is current that is sinked from pixels 140, e.g., when the current data signal Idata is supplied, a predetermined current is sinked from the pixel(s) 140 selected by the first scan signal. The current level of the current data signal Idata may be a predetermined level selected, for example, to meet the requirements of an intended application, or may be experimentally determined, so that a desired voltage can be charged in the pixel 140 during a period in which the first scan signal is supplied. For example, the current level of the current data signal Idata may be set substantially equal to or higher than that of current flowing in the pixel 140 when the pixel 140 emits light with predetermined gray scale value, e.g., a maximum gray scale value (e.g., white).

During the sensing period, the controller 180 converts a voltage applied to each pixel 140 into a digital value, corresponding to the current data signal Idata. The controller stores the converted digital value in storage unit 170. Also, during the sensing period, the controller 180 is electrically coupled to each pixel 140 via the current sink unit 150 and the data lines D1 to Dm.

The storage unit 170 stores the digital value supplied from controller 180 during the sensing period. For example, during the sensing period, a digital value corresponding to all of the pixels 140 in pixel unit 130 may be stored in storage unit 170.

The data driver 120 supplies a first data signal to data lines D1 to Dm in synchronization with the first scan signal, during the driving period. The first data signal may be set to a voltage value corresponding to the digital value stored in the storage unit 170. For example, consider the case where a digital value corresponding to 3V from a specific pixel 140 positioned on an i-th horizontal line and a j-th (j is a natural number) vertical line is stored in the storage unit 170 during the sensing period. The data driver 120 supplies a first data signal of 3V to a j-th data line Dj when the first scan signal is supplied to the i-th horizontal line. That is, the data driver 120 generates a first data signal using the digital value stored in the storage unit 170 when the first scan signals are supplied. The data driver 120 may then supply the first data signal to a corresponding pixel 140.

The data driver 120 may supply a second data signal to data lines D1 to Dm, in synchronization with the second scan signal. The second data signal may include a turn-on second data signal to cause a pixel 140 to emit light, and a turn-off second data signal to prevent a pixel 140 from emitting light.

The pixel unit 130 receives first and second power sources ELVDD and ELVSS supplied from an external source. The first and second power sources ELVDD and ELVSS are supplied to each pixel 140.

The pixels 140 charge a voltage corresponding to the first data signal when the first scan signal is supplied during the driving period. The first data signal may be a voltage corresponding to the current data signal Idata. The voltage value of the first data signal may be set to compensate the mobility and threshold voltage of the driving transistor in each pixel 140.

After the voltage corresponding to the first data signal is charged, the pixels 140 receive the turn-on or turn-off second data signal when the second scan signal is supplied. The pixel 140 receiving the second data signal is set in an emission or non-emission state. For example, the pixels 140 may implement a predetermined gray scale value as the emission time of the pixels 140 is controlled corresponding to a plurality of second data signals during one frame.

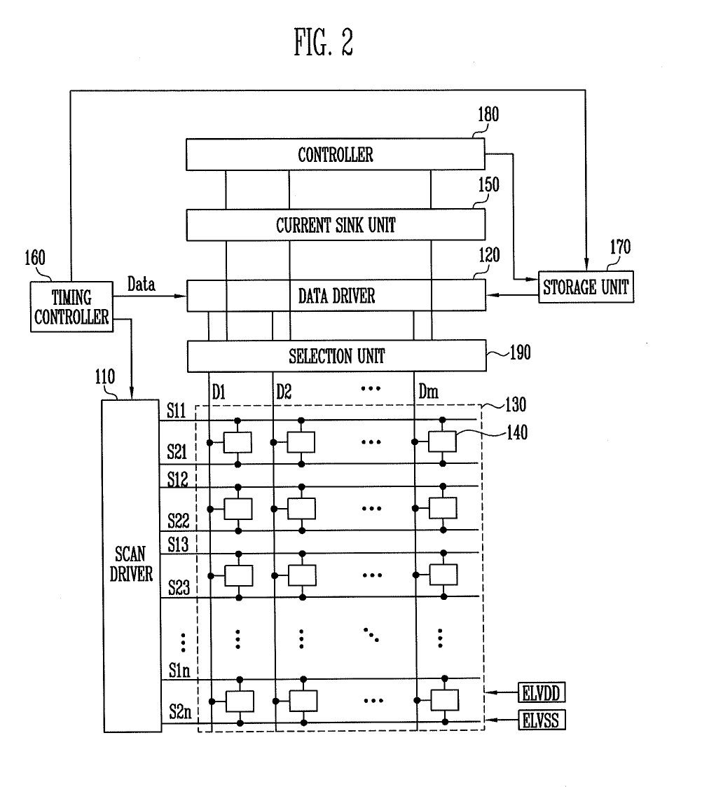

FIG. 2 illustrates another embodiment of an organic light emitting display device. Referring to FIG. 2, the organic light emitting display device includes a selection unit 190 to allow data lines D1 to Dm to be selectively coupled to the current sink unit 150 and the data driver 120.

The selection unit 190 allows current sink unit 150 and data lines D1 to Dm to be electrically coupled to each other during the sensing period. The selection unit 190 also allows the data driver 120 and data lines D1 to Dm to be electrically coupled to each other during the driving period.

FIG. 3 illustrates an embodiment of a pixel, which, for example, may correspond to a pixel located on an n-th horizontal line and an m-th vertical line of either of the aforementioned display devices. Referring to FIG. 3, pixel 140 includes an OLED and a pixel circuit 142 to control the amount of current supplied to the OLED. The OLED generates light with a predetermined luminance corresponding to the amount of current supplied from the pixel circuit 142.

The pixel circuit 142 includes a first driver 144 and a second driver 146. The first driver 144 charges a predetermined voltage corresponding to the current data signal Idata or first data signal, in synchronization with the first scan signal. The first driver 144 includes first to third transistors M1 to M3 and a first capacitor C1.

A first electrode of the first transistor M1 is coupled to the first power source ELVDD. A second electrode of the first transistor M1 is coupled to a second node N2. A gate electrode of the first transistor M1 is coupled to a first node N1. The first transistor M1 controls the amount of current supplied to the OLED via the second driver 146, based on a voltage applied to the first node N1.

A first electrode of the second transistor M2 is coupled to a data line Dm. A second electrode of the second transistor M2 is coupled to the second node N2. A gate electrode of the second transistor M2 is coupled to a first scan line S1n. The second transistor M2 is turned on when the first scan signal is supplied to the first scan line S1n. When second transistor M2 is turned on, data line Dm and second node N2 are electrically coupled to each other.

A first electrode of the third transistor M3 is coupled to the second node N2. A second electrode of the third transistor M3 is coupled to the first node N1. A gate electrode of the third transistor M3 is coupled to the first scan line S1n. The third transistor M3 is turned on when the first scan signal is supplied to the first scan line S1n. When the third transistor M3 is turned on, first and second nodes N1 and N2 are electrically coupled to each other. When first and second nodes N1 and N2 are electrically coupled to each other, the first transistor M1 is diode-coupled.

The first capacitor C1 is coupled between the first power source ELVDD and the first node N1. The first capacitor C1 charges to a voltage which corresponds to the current data signal Idata or first data signal.

The second driver 146 stores the voltage of the second data signal which corresponds to the second scan signal. The second driver 146 controls the supply time of current from the first driver 144 to the OLED. The second driver 146 includes a fourth transistor M4, a fifth transistor M5, and a second capacitor C2.

A first electrode of the fourth transistor M4 is coupled to the second node N2. A second electrode of the fourth transistor M4 is coupled to an anode electrode of the OLED. A gate electrode of the fourth transistor M4 is coupled to a third node N3. The fourth transistor M4 is turned on or turned off based on the second data signal applied to the third node N3.

A first electrode of the fifth transistor M5 is coupled to the data line Dm. A second electrode of the fifth transistor M5 is coupled to the third node N3. A gate electrode of the fifth transistor M5 is coupled to a second scan line S2n. The fifth transistor M5 is turned on when the second scan signal is supplied to the second scan line S2n, in order to allow data line Dm and third node N3 to be electrically coupled to each other.

The second capacitor C2 is coupled between the third node N3 and the first power source ELVDD. The second capacitor C2 stores a voltage corresponding to the second data signal.

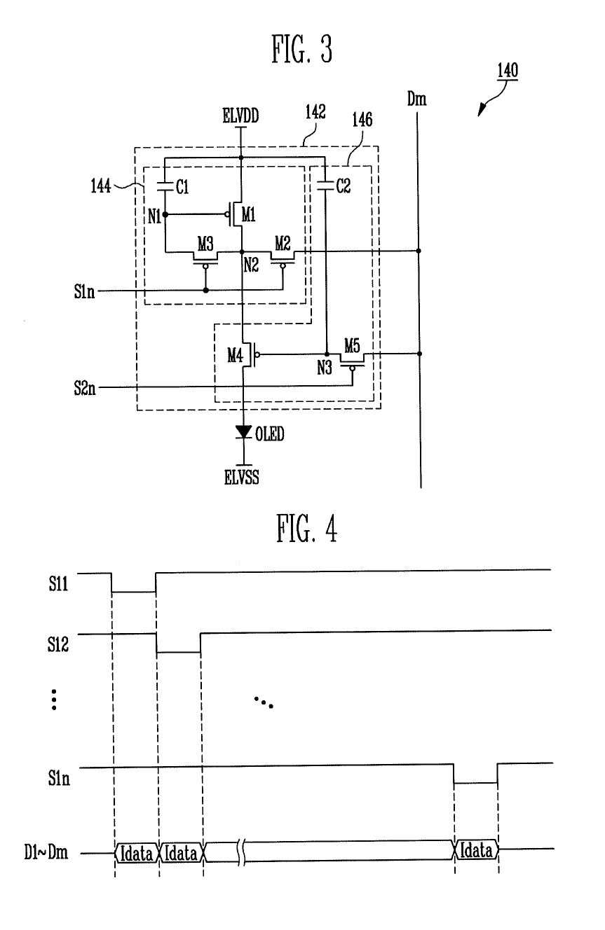

FIG. 4 illustrates an embodiment of a driving waveform supplied to the pixel during a sensing period. The sensing period may be or include a period in which a predetermined voltage is charged in storage unit 170. The sensing period is included once or more after a panel is released. For example, a digital value may be stored in the storage unit by passing through the sensing period whenever a power source is supplied to the panel.

Referring to FIG. 4, the scan driver 110 progressively supplies a first scan signal to the first scan lines S11 to S1n during the sensing period. The current sink unit 150 supplies a current data signal Idata to the data lines D1 to Dm, in synchronization with the first scan signal.

When the first scan signal is supplied to a 1n-th scan line S1n, the second and third transistors M2 and M3 are turned on. When the third transistor M3 is turned on, the first and second nodes N1 and N2 are electrically coupled to each other. In this case, the first transistor M1 is diode-coupled.

When the second transistor M2 is turned on, the second node N2 and the data line Dm are electrically coupled to each other. Then, current corresponding to the current data signal Idata is sinked to the current sink unit 150 via the first power source ELVDD, the first transistor M1, the second transistor M2, and the data line Dm. In this case, a voltage corresponding to current data signal Idata is applied to the first node N1.

The controller 180 receives the voltage applied to the first node N1 via the current sink unit 150 and the data line Dm, converts the received voltage into a digital value, and stores the converted digital value in the storage unit 170. The voltage applied to the first node N1 in each pixel 140 is stored in the storage unit 170 by repeating the aforementioned procedure during the sensing period.

The voltage applied to the first node N1 in each pixel 140, corresponding to the current data signal Idata during the sensing period, is set to compensate the threshold voltage and mobility of the first transistor M1. That is, a voltage is applied to the first node N1 of each pixel to allow current corresponding to the current data signal Idata to flow regardless of threshold voltage and mobility. Additionally, in accordance with one embodiment, the sensing period occurs at the time when an image is not displayed, e.g., just after the power source is input. Thus, a sufficient time can be assigned to the sensing period. Accordingly, a desired voltage can be stably stored in storage unit 170.

FIG. 5 illustrates another embodiment of a driving waveform supplied during a driving period. The driving period may be or include a period in which a desired image is displayed in pixel unit 130. Referring to FIG. 5, the scan driver 110 progressively supplies a first scan signal to the first scan lines S11 to S1n during the driving period. The data driver 120 supplies a first data signal DS1 to data lines D1 to Dm in synchronization with the first scan signal.

When the first scan signal is supplied to a 1n-th scan line S1n, the second and third transistors M2 and M3 are turned on. When the third transistor M3 is turned on, the first and second nodes N1 and N2 are electrically coupled to each other. When the second transistor M2 is turned on, the second node N2 and data line Dm are electrically coupled to each other. Then, the first data signal DS1 is supplied to the first node N1, and the first capacitor C1 stores a voltage corresponding to the first data signal DS1.

The first data signal DS1 is set to a voltage corresponding to a digital value stored in the storage unit 170. In this case, a desired current can be supplied to the OLED regardless of the threshold voltage and mobility of the first transistor M1.

After the first scan signal is supplied to the 1n-th scan line S1n, a second scan signal is supplied to a 2n-th scan line S2n. In addition, a second data signal is supplied to data line Dm in synchronization with the second scan signal. When the second scan signal is supplied to the 2n-th scan line S2n, the fifth transistor M5 is turned on. When the fifth transistor m5 is turned on, the third node N3 and data line Dm are electrically coupled to each other. In this case, the second data signal is supplied to the third node N3. Accordingly, a voltage corresponding to the second data signal is stored in the second capacitor C2.

The second data signal is set to a voltage at which the fourth transistor M4 is turned on or turned off. Thus, when the second data signal is supplied to the third node N3, the fourth transistor M4 is set in a turn-on or turn-off state. For example, if a turn-on second data signal is supplied to the third node N3, the fourth transistor M4 is turned on. Accordingly, current from the first transistor M1 is supplied to the OLED, so that the pixel 140 is set in the emission state. When a turn-off second data signal is supplied to the third node N3, the fourth transistor M4 is turned off. Accordingly, the OLED is set in the non-emission state.

The second scan signal, and the second data signal which is synchronized with the second scan signal, may be supplied two or more times at a predetermined interval during one frame. Thus, as the emission and non-emission of pixel 140 are controlled to correspond to the supply interval of the second scan signal, a predetermined gray scale value is implemented.

The first data signal DS1, which is supplied in synchronization with the first scan signal, is used to charge a predetermined voltage in pixel 140. Thus, it is unnecessary to continuously supply the first data signal DS1 after the voltage of the first data signal DS1 is charged in the first capacitor C1. For example, the first data signal DS1 may be supplied once for every plurality of frames. The supply interval of the first data signal DS1 may correspond to a predetermined interval based, for example, on an intended application, or may be experimentally determined in consideration of, for example, panel resolution, the storage capacity of the first capacitor C1, or another parameter. A second data signal DS2 may be supplied at least once for each frame, so that a gray scale value can be implemented.

In the present embodiment, current from pixels 140 is sinked during the sensing period, a voltage corresponding to the sinked current is converted into a digital value, and the converted digital value is stored in storage unit 170. Subsequently, a predetermined gray scale value is implemented while controlling the emission time after the voltage of the first data signal, corresponding to the digital value stored in the storage unit 170 is charged in the pixels 140 during the driving period.

Current is not sinked during the driving period, and the first data signal that is a voltage value corresponding to the current is supplied to the pixels 140. When the first data signal is supplied to the pixels 140, the charging time of the pixels 140 is reduced. The emission and non-emission of pixels 140 are controlled using the second data signal, so that the present embodiment can be applied to various types of digital driving devices.

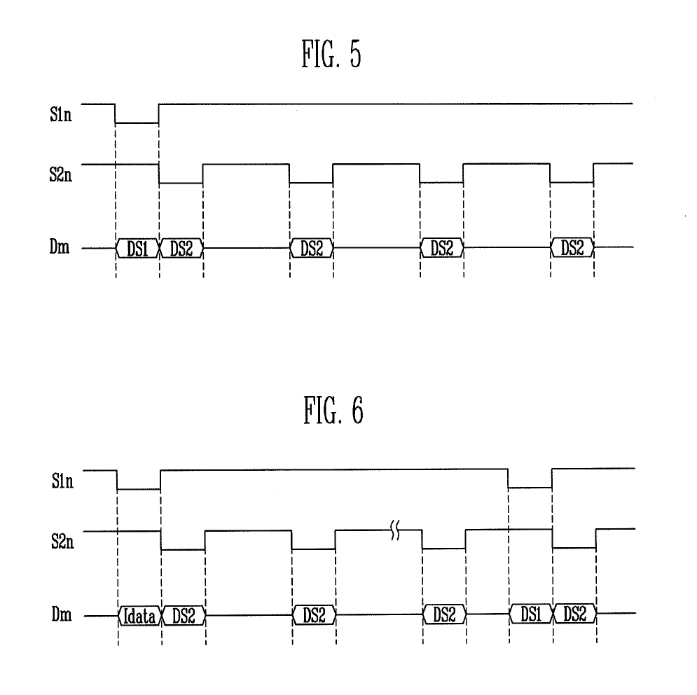

FIG. 6 illustrates another embodiment of a pixel driving waveform. Referring to FIG. 6, during a first frame after a power source is input, the first scan signal is supplied to a first scan line S1n and the current data signal Idata is supplied in synchronization with the first scan signal.

When the first scan signal is supplied to the first scan line S1n, the second and third transistors M2 and M3 are turned on. Then, current corresponding to the current data signal Idata is sinked to the current sink unit 150 via the first power source, first transistor M1, second transistor M2, and data line Dm. In this case, a voltage corresponding to the current data signal Idata is applied to the first node N1.

The controller 180 receives a voltage applied to the first node N1 via the current sink unit 150 and data line Dm, converts the received voltage into a digital value, and stores the converted digital value in the storage unit 170.

Subsequently, a second scan signal is supplied to the second scan line S2n at a predetermined interval. A second data signal DS2 is supplied to data line Dm in synchronization with the second scan signal. Then, the pixel 140 emits or does not emit light corresponding to the second data signal DS2. When light is emitted, a predetermined gray scale value is implemented.

When the first scan signal is supplied to the first scan line S1n after the first frame, the first data signal DS1 (generated by the digital value in storage unit 170) is supplied to the data line Dm. That is, in this embodiment, a digital value is stored in storage unit 170 by supplying the current data signal Idata during at least one frame in the driving period without any separate sensing period. Also, a first data signal DS1 corresponding to the digital value is supplied to the pixel 140 during a subsequent frame.

Although the previous embodiments have been described to include PMOS transistors, NMOS transistors may be used in other embodiments.

In the present embodiment, the OLED of a pixel may generate red, green, or blue light at a grays scale value corresponding to the amount of current supplied from the driving transistor. In other embodiments, the OLED of a pixel may generate white light at a gray scale value corresponding to the amount of the current supplied from the driving transistor. When the OLED generates white light, a color image may be implemented using, for example, a separate color filter.

By way of summation and review, an organic light emitting display device includes a plurality of pixels arranged in a matrix form at intersection portions of a plurality of data lines, a plurality of scan lines, and a plurality of power lines. Each pixel stores a voltage corresponding to a data signal, and supplies current to an OLED corresponding to the stored voltage using a driving transistor. The OLED, therefore, generates light with a predetermined luminance.

The threshold voltage and mobility of the driving transistor in each pixel may become non-uniform due to process variations, age, temperature, or other influences. When this occurs, an image with a desired luminance is not displayed.

A method for supplying current as a data signal has been proposed to compensate for the non-uniformity of the threshold voltage and mobility of the driving transistor. When the current is supplied as the data signal, luminance may be implemented regardless of variation in the threshold voltage and mobility of the driving transistor. However, supplying the current as a data signal makes it difficult to accurately express lower gray scale values. In other words, when a fine current is supplied to implement a lower gray scale value, a desired voltage may not charged in a pixel for a predetermined time (e.g., one horizontal period (1H)). As a result, an image with a desired gray scale is not implemented.

In accordance with one or more of the aforementioned embodiments, current corresponding to a current data signal is sinked from a pixel and a voltage applied to the pixel is stored as a digital value in the storage unit. Subsequently, the amount of current to be supplied is determined by converting the digital value stored in the storage unit into a first data signal as a voltage, and by supplying the converted first data signal to the pixel. A gray scale value is then implemented while controlling an emission time using a second data signal, thereby improving display quality.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. A pixel, comprising:
an organic light emitting diode (OLED);
a first driver configured to supply a predetermined current to the OLED based on a current data signal or first data signal; and
a second driver coupled between the first driver and OLED, the second driver to control the coupling between the first driver and OLED based on a second data signal.

2. The pixel as claimed in claim 1, wherein the first driver includes:
a first transistor between a first power source and a second node which is electrically coupled to the second driver, the first transistor having a gate electrode coupled to a first node;
a second transistor coupled between the second node and a data line, the second transistor to be turned on when a first scan signal is supplied to a first scan line;
a third transistor coupled between the first and second nodes, the third transistor to be turned on when the first scan signal is supplied; and
a first capacitor coupled between the first node and the first power source.

3. The pixel as claimed in claim 2, wherein the predetermined current flows into a data line through the first power source, the first transistor, and the second transistor when the current data signal is supplied.

4. The pixel as claimed in claim 3, wherein the first data signal is set to a voltage substantially equal to a voltage applied to the first node, corresponding to the current data signal.

5. The pixel as claimed in claim 2, wherein the second driver includes:
a fourth transistor coupled between the second node and OLED;
a fifth transistor coupled between a gate electrode of the fourth transistor and a data line, the fifth transistor to be turned on when a second scan signal is supplied to a second scan line; and
a second capacitor coupled between the gate electrode of the fourth transistor and the first power source.

6. The pixel as claimed in claim 5, wherein the second data signal is to be set to a turn-on voltage to turn on the fourth transistor to cause the OLED to emit light, or to a turn-off voltage to turn off the fourth transistor to prevent the OLED from emitting light.

7. An organic light emitting display device, comprising:
a scan driver configured to supply a first scan signal to first scan lines and to supply a second scan signal to second scan lines;
a data driver configured to supply first and second data signals to data lines;
a current sink unit configured to supply a current data signal to the data lines; and
pixels in an area defined by the first scan lines, the second scan lines, and the data lines, wherein an organic light emitting diode (OLED) of each pixel is to receive an amount of current controlled based on one of the current data signal or the first data signal, and wherein the OLED has an emission time controlled based on the second data signal.

8. The device as claimed in claim 7, further comprising:
a selection unit configured to allow the data lines to be selectively coupled to the current sink unit and the data driver.

9. The device as claimed in claim 7, wherein the current sink unit sinks a predetermined current from the pixels based on the current data signal and synchronized with the first scan signal at least once.

10. The device as claimed in claim 9, further comprising:
a controller configured to convert a voltage applied to each pixel into a digital value corresponding to the predetermined current, and to store the converted digital value in a storage unit.

11. The device as claimed in claim 10, wherein the data driver is to convert the digital value into the first data signal as a voltage, and is to supply the converted first data signal to the pixels, in synchronization with the first scan signal.

12. The device as claimed in claim 11, wherein the first data signal is supplied for each of a plurality of frames.

13. The device as claimed in claim 9, wherein the current level of the current data signal is set to allow a voltage corresponding to the current data signal to be charged in the pixels during a period in which the first scan signal is supplied.

14. The device as claimed in claim 7, wherein the data driver is to supply the second data signal in synchronization with the second scan signal.

15. The device as claimed in claim 14, wherein the second data signal is set to one of a turn-on voltage at which the pixels emit light or a turn-off voltage at which the pixels do not emit light.

16. The device as claimed in claim 14, wherein the second data signal is supplied to the pixels at least once for each frame.

17. The device as claimed in claim 7, wherein each pixel includes:
an organic light emitting diode (OLED);
a first driver configured to supply a predetermined current to the organic light emitting diode based on the current data signal or first data signal; and
a second driver coupled between the first driver and OLED, wherein the second driver is to control the coupling between the first driver and OLED based on the second data signal.

18. The device as claimed in claim 17, wherein the first driver includes:
a first transistor coupled between a first power source and a second node electrically coupled to the second driver, the first transistor having a gate electrode coupled to a first node;
a second transistor coupled between the second node and a data line, the second transistor to be turned on when a first scan signal is supplied to a first scan line;
a third transistor coupled between the first and second nodes, the third transistor to be turned on when the first scan signal is supplied to the first scan line; and
a first capacitor coupled between the first node and the first power source.

19. The device as claimed in claim 18, wherein the second driver includes:
a fourth transistor coupled between the second node and the OLED;
a fifth transistor coupled between a gate electrode of the fourth transistor and the data line, the fifth transistor to be turned on when a second scan signal is supplied to a specific second scan line; and
a second capacitor coupled between the gate electrode of the fourth transistor and the first power source.

20. A method of driving an organic light emitting display device, the method comprising:
sinking current based on a current data signal from a pixel;
converting a voltage applied to the pixel into a digital value based on the sinked current and storing the converted digital value;
charging a predetermined voltage by supplying, to the pixel, a first data signal as a voltage corresponding to the digital value; and
controlling an emission time of the pixel based on a second data signal.
